(19) United States
(12) Patent Application Publication
(10) Pub. No.: US 2009/0267715 A1
(43) Pub. Date: Oct. 29, 2009

(54) ELECTROMAGNETIC RELAY

(75) Inventors: Norio Fukui, Kyoto (JP); Shinichi Furusho, Kyoto (JP); Ryota Minowa, Kyoto (JP)

Correspondence Address: OSHA LIANG L.L.P., TWO HOUSTON CENTER, 909 FANNIN, SUITE 3500, HOUSTON, TX, 77010, US

(73) Assignee: OMRON CORPORATION, Kyoto (JP)

(21) Appl. No.: 12/064,315

(22) PCT Filed: Aug. 22, 2006
(86) PCT No.: PCT/JP2006/316376

§ 371 Date: Feb. 20, 2008

(30) Foreign Application Priority Data
Aug. 25, 2005 (JP) 2005-244164

(51) Int. Cl. H01H 50/00

(52) U.S. Cl. 335/156

(57) ABSTRACT

An electromagnetic relay capable of smoothly rotating a movable iron member by eliminating the effect of foreign matters produced on the contact surface of the movable iron piece on a core even if the drive voltage of an electromagnetic block is small. The attracting surface (12) of the movable iron piece (11) is attracted to and separated from the magnetic pole surface (8b) of the core (5) by magnetizing and demagnetizing the electromagnetic block (2) formed by wrapping a coil (7) around the core (5) to open and close a contact by driving a contact block (3). A foreign matter turnout part (13) is formed at at least either of the attraction face (12) of the movable iron piece (11) and the magnetic pole surface (8b) of the core (17).

### TECHNICAL FIELD

The present invention relates to electromagnetic relays, in particular, to an electromagnetic relay that operates at a small drive voltage.

### BACKGROUND ART

An electromagnetic relay equipped with an electromagnetic block having the following configuration is conventionally known (see e.g., patent document 1). The electromagnetic block is formed by wrapping a coil around a core, where one magnetic pole surface of the core is contacted with one end of a movable iron member and the other magnetic pole surface is attracted to and separated from the other end of the movable iron member when current flows to the coil.

Patent document 1: Japanese Laid-Open Patent Publication No. 2001-155610

### DISCLOSURE OF THE INVENTION

### Problems to be Solved by the Invention

However, in the conventional electromagnetic relay, the attracting surface of the movable iron member and the magnetic pole surface of the core are configured to area contact each other. Foreign matters such as adhesive substance appear due to various effects at the area contacting portion. In this case, the movable iron member cannot smoothly rotate due to the foreign matters that have appeared if the drive voltage of the electromagnetic block is small.

The present invention aims to provide an electromagnetic block capable of smoothly rotating the movable iron member by eliminating the effect of foreign matters produced on the contact surface of the movable iron member and the core even if the drive voltage of the electromagnetic block is small.

### Means for Solving the Problems

As a means for solving the problem, the present invention provides an electromagnetic relay for driving a contact block and opening and closing a contact by magnetizing and demagnetizing an electromagnetic block formed by wrapping a coil around a core, and attracting and separating an attracting surface of a movable iron member to and from a magnetic pole surface of the core; wherein a foreign matter turnout part is formed in at least one of the attracting surface of the movable iron member or the magnetic pole surface of the core.

According to such configuration, the foreign matters that appeared between the attracting surface of the movable iron member and the magnetic pole surface of the core are collected in the foreign matter turnout part, thereby preventing the foreign matters from remaining at the directly contacting portion. Therefore, when the movable iron member rotates, the smooth operation is reliably prevented from being inhibited by the effect of the foreign matters even if the drive voltage is small and the returning force of the movable iron member, that is, the spring force of the contact piece of the movable contact terminal and the hinge spring is small.

The foreign matter turnout part is configured by a plurality of grooves arranged in parallel.

The foreign matter turnout part is configured by a plurality of grooves arranged to intersect each other.

Furthermore, the foreign matter turnout part is configured by a plurality of concave parts arranged in parallel.

### Effect of the Invention

According to the present invention, since the foreign matter turnout part is formed in at least one of the attracting surface of the movable iron member or the magnetic pole surface of the core, the operating characteristics of the movable iron member is reliably prevented from degrading due to the effect of the foreign matters produced between the contact surfaces.

### BRIEF DESCRIPTION OF THE DRAWINGS

FIG. 1 is a front cross sectional view showing an electronic relay according to one embodiment of the present invention.

FIG. 2 is a perspective view showing an electromagnetic block of FIG. 1.

FIG. 3 is a perspective view showing a movable iron member according to one embodiment of the present invention.

FIG. 4 is a perspective view showing a movable iron member according to another embodiment.

FIG. 5 is a perspective view showing a movable iron member according to another embodiment.

FIG. 6 is a perspective view showing a movable iron member according to another embodiment.

### DESCRIPTION OF SYMBOLS

1 base
2 electromagnetic block
3 contact block
4 case
5 core
6 spool
7 coil
8a, 8b magnetic pole surface
9a, 9b collar part
10 coil terminal
11 movable iron member
12 attracting surface
13 foreign matter turnout part
14 groove
15 projection
16 concave part
17 insulation frame
18 fixed contact piece
19a, 19b movable contact piece
20a, 20b fixed contact
21a, 21b movable contact
22 card
23 return spring

### BEST MODE FOR CARRYING OUT THE INVENTION

The embodiment according to the present invention will now be described according to the accompanied drawings.

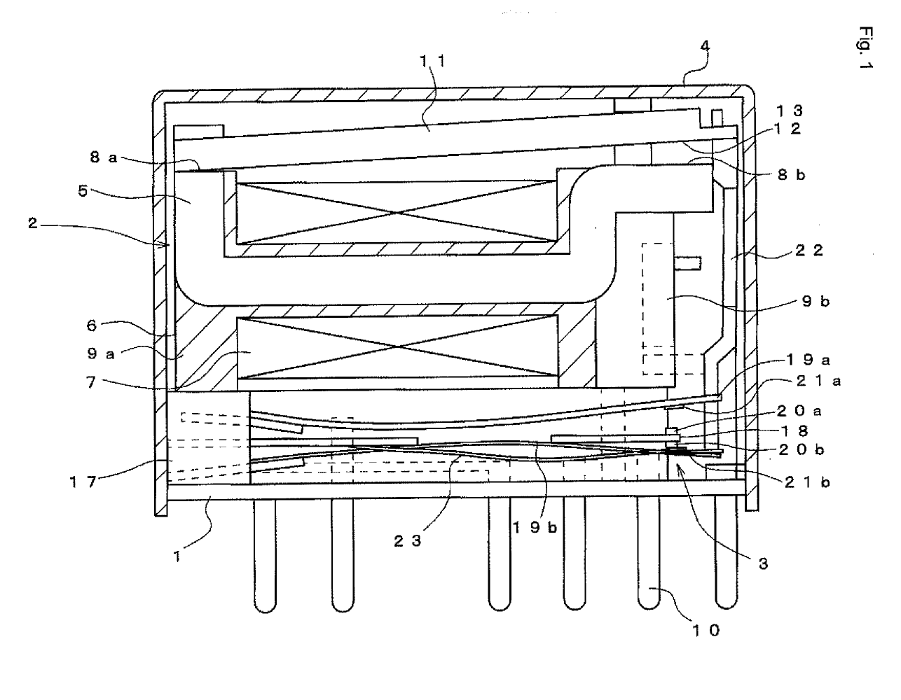

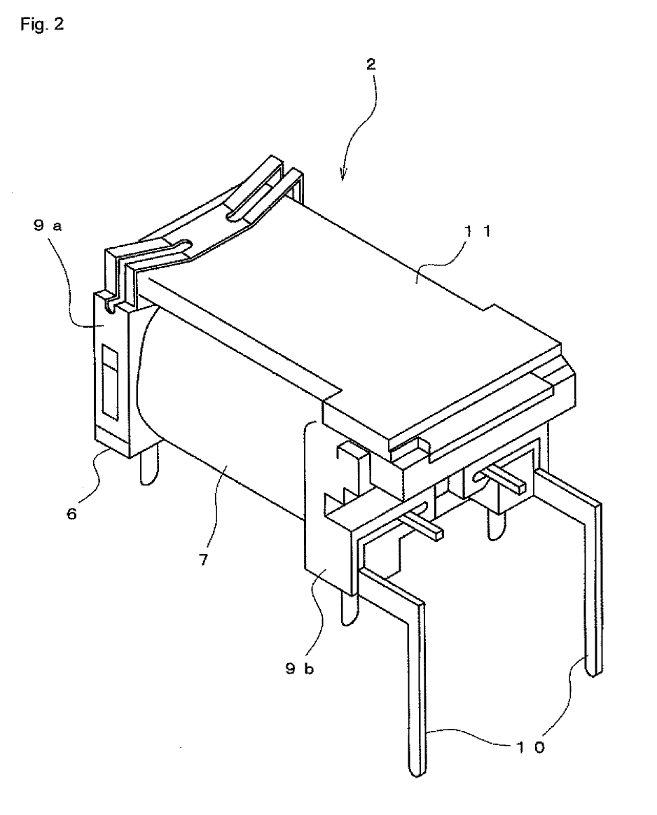

FIG. 1 shows an electromagnetic relay according to the present embodiment. In brief, the electromagnetic relay has a configuration in which an electromagnetic block 2 (see FIG. 2) and a contact block 3 are arranged on a base 1, and a case 4 is placed thereon, as shown in FIG. 1.

The electromagnetic block 2 has a configuration in which a coil 7 is wrapped around a core 5 by way of a spool 6. As shown in FIG. 1, the core 5 has both ends bent at substantially right angle, where one end is further bent at right angle. Magnetic pole surfaces 8a, 8b are respectively formed at end face on one end and a side face of the bent part on the other end of the core 5. The spool 6 exposes the magnetic pole surfaces 8a, 8b from collar parts 9a, 9b at both ends by insert molding the core 5. A pair of coil terminals 10 is arranged at one collar part 9b. Both ends (pull-out lines) of the wrapped coil 7 are winded to each coil terminal 10.

A movable iron member 11 is arranged on the upper side of the electromagnetic block 2. The movable iron member 11 has one end contacting one magnetic pole surface 8a of the core 5 and the attracting surface 12 of the other end attracting to and separating from the other magnetic pole surface 8b by swinging with the contacting portion as the supporting point.

A foreign matter turnout part 13 is formed in the attracting surface 12, as shown in FIGS. 3 to 6. The foreign matter turnout part 13 prevents the foreign matters produced when the movable iron member 11 is rotated and attracted to and separated from the magnetic pole surface 8b of the core 5 from being interposed in between the magnetic pole surface 8b. The cause of production of the foreign matter is not currently known, but is assumed to be the result of thermal effect on the plating performed on the surface of the movable iron member 11 and components etc. contained in the surrounding atmosphere. Therefore, the configuration of the foreign matter turnout part 13 may be appropriately design changed according to the difference in material to be used and the environment to be used in.

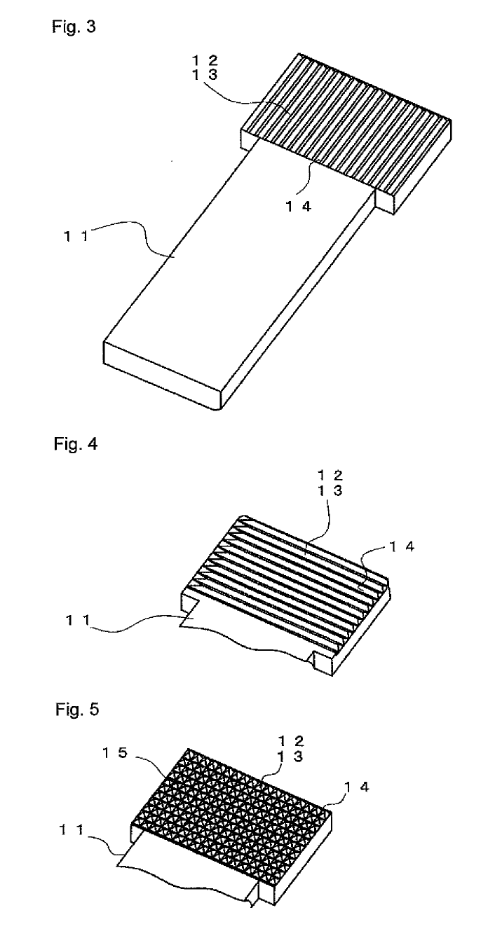

In Fig, 3, configuration is made by a plurality of grooves 14 arranged in parallel in the longitudinal direction of the movable iron member 11. In FIG. 4, configuration is made by a plurality of grooves 14 arranged in parallel in the short side direction of the movable iron member 11. The width and the depth of the groove 14, the interval between the grooves, and the like can be appropriately design changed. Such grooves 14 can be simultaneously and easily formed when press working the movable iron member 11. The direction of forming the grooves 14 is not limited to the above, and may be formed diagonally.

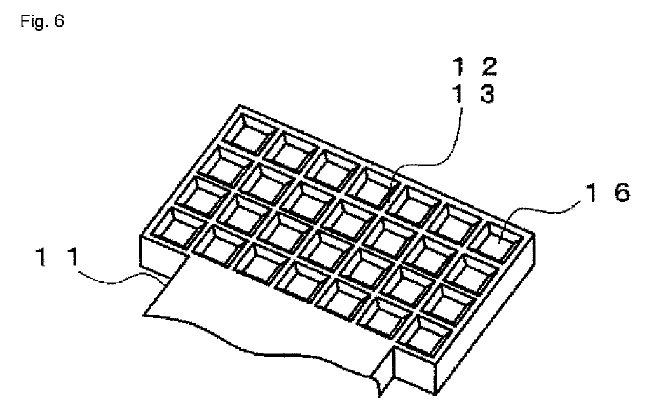

In FIG. 5, configuration is made by a plurality of projections 15 formed by a plurality of grooves 14 extending in the longitudinal direction and the short side direction of the movable iron member 11 and intersecting each other. In such configuration, the produced foreign matters can be reliably collected even if concentrated at a specific location since the grooves are communicated.

In FIG. 6, configuration in which a concave part 16 of rectangular shape is arranged in a lattice form is realized. In such configuration, the contact area between the attracting surface 12 of the movable iron member 11 and the magnetic pole surface 8b of the core 5 is small and a space for turning out the foreign matters can be sufficiently obtained. Therefore, the effect is particularly exhibited when the foreign matters having high viscosity appear.

The contact block 3 is arranged below the electromagnetic block 2, is configured by a fixed contact piece 18 and movable contact pieces 19a, 19b and supported from above and below by an insulation frame 17. Fixed contacts 20a, 20b formed on both surfaces of the fixed contact piece 18 can be attracted to and separated from movable contacts 21a, 21b formed on each movable contact piece 19a, 19b. The fixed contact 20a on the upper surface of the fixed contact piece 18 will be described as a constantly opened fixed contact, the fixed contact 20b on the lower surface as the constantly closed fixed contact, the movable contact 21a of the movable contact piece 19a on the upper side as the constantly opened movable contact, and the movable contact 21b of the movable contact piece 19b on the lower side as the constantly closed movable contact.

The movable iron member 11 of the electromagnetic block 2 and the movable contact pieces 19a, 19b of the contact block 3 are connected by way of a card 22. That is, the distal end portion of the movable iron member 11 is connected to the upper end of the card 22, and both movable contact pieces 19a, 19b are inserted to slits formed at the lower end side of the card 22. Thus, when the movable iron member 11 is rotated by magnetizing and demagnetizing the electromagnetic block 2, the movable contact pieces 19a, 19b displace by way of the card 22, and the contact switches as hereinafter described.

The movable iron member 11 has the distal end side biased upward by a return spring 23 fixed on the insulation frame 17, thereby providing a returning force when the electromagnetic block 2 is demagnetized.

The operation of such configuration will be described.

When the coil block of before current is flowed to the coil 7 is in a demagnetized state, the movable iron member 11 maintains a state in which the attracting surface 12 is separated from the magnetic pole surface 8b by the movable contact piece 19a, 19b and the biasing force of the return spring 23. The constantly closed movable contact 21b closes to the constantly closed fixed contact 20b.

When the current flows to the coil 7 and the coil block is magnetized, the attracting surface 12 on one end side of the movable iron member 11 is attracted to the magnetic pole surface 8b of the core 5 and rotated. The movable contact pieces 19a, 19b are both displaced to the lower side by way of the card 22, whereby the constantly closed movable contact 21b separates away from the constantly closed fixed contact 20b and the constantly opened movable contact 21a closes to the constantly closed fixed contact 20a.

The movable iron member 11 is rotated and the contacts to be closed are switched by magnetizing and demagnetizing the electromagnetic block 2, but foreign matters such as adhesive substances sometimes tend to attach to the attracting surface 12 of the movable iron member 11 and the magnetic pole surface 8b due to the effects of the plating formed on the surface of the movable iron member 11 and the components contained in the surrounding atmosphere after use over a long period of time. In this case, the foreign matters disappear from the portion where the attracting surface 12 and the magnetic pole surface 8b are directly contacted and all the foreign matters are held in the foreign matter turnout part 13 by the function of the foreign matter turnout part 13 formed in the attracting surface 12 of the movable iron member 11. Furthermore, the contact area is small and the closely attached state is less likely to be obtained. Therefore, cases where the attracting surface 12 of the movable iron member 11 and the magnetic pole surface 8b closely attach and the movable iron member 11 is disabled from rotating, or the rotating operation of the movable iron member 11 is delayed are appropriately avoided. Thus, the opening and closing operation of the contacts in the contact block 3 is accurately performed without being adversely affected.

In the embodiment, the foreign matter turnout part 13 is formed in the attracting surface 12 of the movable iron member 11, but may be formed in the magnetic pole surface 8b of the core 5 or may be formed on both the attracting surface 12 and the magnetic pole surface 8b. When formed in the magnetic pole surface 8b of the core 5, the grooves etc. may be formed through press working for ultimately forming the magnetic pole surface 8b, and thus can be easily formed without increasing the processing steps.

### INDUSTRIAL APPLICABILITY

The electromagnetic relay according to the present invention is not limited to the above embodiment and is also applicable to other electromagnetic relays.

1. An electromagnetic relay for driving a contact block and opening and closing a contact by magnetizing and demagnetizing an electromagnetic block formed by wrapping a coil around a core, and attracting and separating an attracting surface of a movable iron member to and from a magnetic pole surface of the core; wherein
a foreign matter turnout part is formed in at least one of the attracting surface of the movable iron member or the magnetic pole surface of the core.

2. The electromagnetic relay according to claim 1, wherein the foreign matter turnout part is configured by a plurality of grooves arranged in parallel.

3. The electromagnetic relay according to claim 1, wherein the foreign matter turnout part is configured by a plurality of grooves arranged to intersect each other.

4. The electromagnetic relay according to claim 1, wherein the foreign matter turnout part is configured by a plurality of concave parts arranged in parallel.
